(19) United States
(12) Patent Application Publication
(10) Pub. No.: US 2004/0144858 A1
(43) Pub. Date: Jul. 29, 2004

(54) Wet loop water spray enclosure with translucent covering

(76) Inventor: Clemon Sigler JR., South Euclid, OH (US)

Correspondence Address: FAY, SHARPE, FAGAN, MINNICH & McKEE, LLP, Seventh Floor, 1100 Superior Avenue, Cleveland, OH, 44114-2518, US

(21) Appl. No.: 10/753,257

(22) Filed: Jan. 8, 2004

Related U.S. Application Data
(60) Provisional application No. 60/439,351, filed on Jan. 10, 2003.

(51) Int. Cl. B05B 15/00

(52) U.S. Cl. 239/289

(57) ABSTRACT

A water spray enclosure comprises a plurality of interconnected tubes defining a framework, wherein at least some of the plurality of tubes are fluidically interconnected to each other so as to define a flow-path through the framework. A flexible covering is connected to and substantially coextensive with the framework and cooperates with the framework to define a tunnel-like enclosure having opposite first and second open ends and an enclosure portion between the ends. The covering is at least partially translucent. An inlet fitting is connected to one of said tubes of said framework and in fluid communication with said flow-path. The inlet filling is adapted for fluidic connection to a water supply conduit for supplying water to said flow-path. A plurality of spray heads are in communication with said flow-path and are adapted for emitting a spray of water from said flow path into the enclosure portion between the first and second open ends. The covering includes aquatic indicia to simulate an underwater experience to those within the enclosure. The framework includes a plurality of arches for strength and optimum water spray.

### CROSS-REFERENCE TO RELATED APPLICATION

This application claims priority from and benefit of the filing date of U.S. provisional patent application Serial No. 60/439,351 filed Jan. 10, 2003.

### BACKGROUND OF THE INVENTION

A wide variety of water spray amusement devices are known for use by children and others. These known devices have been found to be deficient for many reasons. Many of the devices are not able to be disassembled for storage. Others provide a water spray but do not provide users with an illusion of being submerged or surrounded in water at or near the ocean. Still others are sub-optimal because they do not provide any type of enclosure for protection from the sun and also for amusement. In light of the foregoing, a need has been identified for a new water spray enclosure as described herein.

### SUMMARY OF THE INVENTION

In accordance with the present invention, a water spray enclosure comprises a plurality of interconnected tubes defining a framework, wherein at least some of the plurality of tubes are fluidically interconnected to each other so as to define a flow-path through the framework. A flexible covering is connected to and substantially coextensive with the framework and cooperates with the framework to define a tunnel-like enclosure having opposite first and second open ends and an enclosure portion between the ends. The covering is at least partially translucent. An inlet fitting is connected to one of said tubes of said framework and in fluid communication with said flow-path. The inlet fitting is adapted for fluidic connection to a water supply conduit for supplying water to said flow-path. A plurality of spray heads are in communication with said flow-path and are adapted for emitting a spray of water from said flow path into the enclosure portion between the first and second open ends.

### BRIEF DESCRIPTION OF THE DRAWINGS

The present invention comprises various components and arrangements of components, preferred embodiments of which are illustrated in the accompanying drawings that form a part hereof and wherein:

FIG. 1 is a rear elevational view of a water spray enclosure formed in accordance with the present invention;

FIG. 2 is a side elevational view of the water spray enclosure of FIG. 1 as taken along line 2-2 of FIG. 1;

FIG. 3 is a partial isometric view of the water spray enclosure of FIG. 1;

FIG. 3A is a partial view that shows one example of a suitable structure and method for forming a water spray enclosure in accordance with the present development;

FIG. 4 is a partial side elevational view of the water spray enclosure FIG. 1 and showing a preferred translucent covering with aquatic creature and other indicia thereon;

FIG. 5 illustrates one example of a spray head formed in accordance with the present invention;

FIG. 6 illustrates a second spray head embodiment;

FIG. 7 is another isometric view of a water spray enclosure formed in accordance with the present invention;

FIG. 8 shows a preferred anchoring system.

### DETAILED DESCRIPTION OF PREFERRED EMBODIMENT

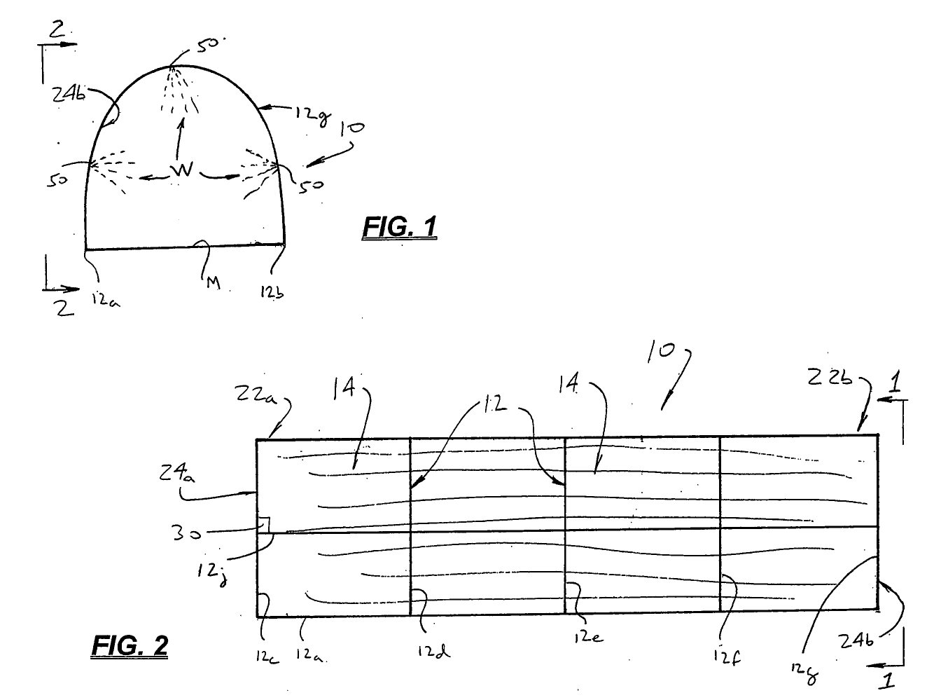

Referring first to FIGS. 1-3A, a water spray enclosure 10 comprises a frame or skeleton 12 and a covering 14 connected to the frame. The frame 12 and covering 14 cooperate to define a tunnel-like enclosure as shown herein. The tunnel-like enclosure comprises opposite first and second ends 22a,22b that preferably define like open mouths 24a,24b, respectively. The tunnel-like enclosure and mouths 24a,24b thereof are conformed and dimensioned so that children (and optionally adults) can walk or run in and/or through the enclosure, i.e., children and/or adult users enter the enclosure via either of the mouths 24a,24b, move about inside the enclosure and exit the enclosure through either of the mouths 24a,24b. The enclosure 10 can be any desired or suitable length such as 8 feet or 16 feet long as measured from end 22a to end 22b. The maximum height of the enclosure can be varied but is preferably between about 5 feet and 6 feet.

The frame 12 is at least partially and preferably fully defined by a network of interconnected conduits such as plastic tubing, e.g., PVC pipes or the like, at least some of which are fluidically interconnected. In the illustrated embodiment, the frame 12 comprises first and second axial base tubes 12a,12b arranged parallel to each other. A plurality of wet loop or arch tubes 12c,12d,12e,12f,12g are connected at their respective opposite ends to the first and second base tubes 12a,12b. One or more intermediate tubes 12j,12k are preferably provided and extend parallel to the base tubes 12a,12b at about the midpoint of the of the height and/or at the apex of the arch tubes 12c-12g. The arched tubes 12c-12g are preferably arranged in spaced parallel relation to each other, and the combination of the arched shaped and parallel spaced arrangement provides superior strength to the framework 12 and allows for an optimized water spray pattern as disclosed further below.

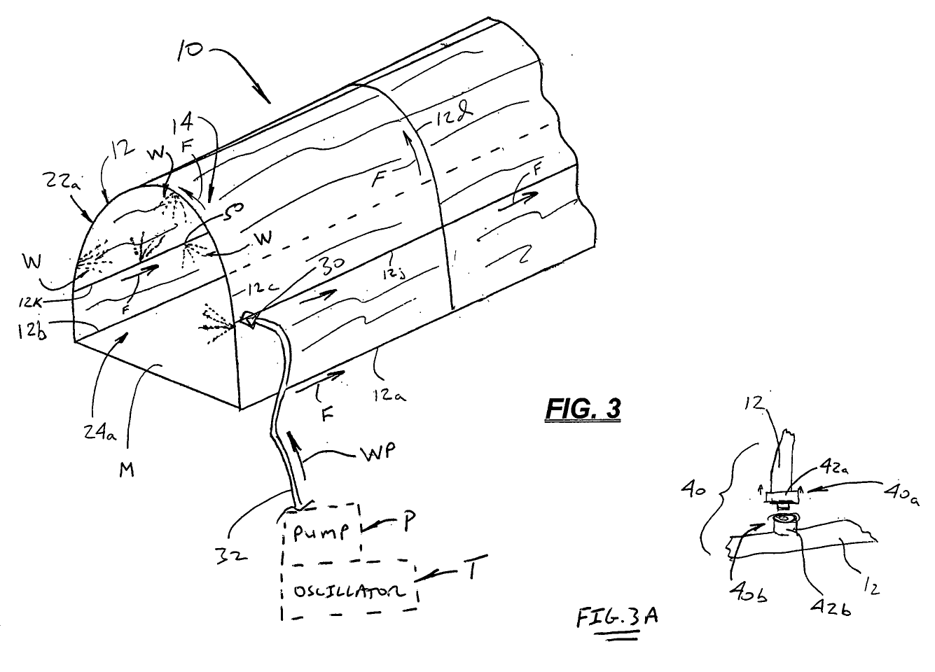

Regardless of their exact arrangement, the tubes 12a-12k define the tunnel-like enclosure as described above. The frame 12 of the enclosure 10 comprises at least one water inlet fitting 30 adapted for releasable fluidic connection to an ordinary garden hose 32 or the like that supplies water under pressure WP from a source. An electric pump P (FIG. 3) is optionally provided to increase the pressure of water supplied to the inlet fitting 30 via hose 32. The fitting 30 is in direct fluid communication with one of the tubes 12a-12k, preferably one of the intermediate tubes 12j,12k such as the tube 12j as shown, and this tube that is in direct fluid communication with the inlet fitting 30 thus functions as a water supply tube. Preferably at least each of the arch tubes 12c-12g and both intermediate tubes 12j,12k are connected in fluid communication to each other and the water supply tube (the tube 12j in the present example). As such, water from the hose 32 flows under pressure into and through at least some of the frame members 12a-12k and preferably at least all of the arch tubes 12c-12g and intermediate tubes 12j,12k on a flow-path as indicated by arrows F. An oscillator T or other pulsating means are optionally provided as part of the filling 30, pump P and/or elsewhere to establish pulsation in the flow F.

The tubes 12a-12k are connected in any conventional manner; non-fluidic tube inter-connections are made by friction, brackets, threading, clips, ties or the like; fluidic tube inter-connections are made by threaded or snap or friction couplings or by any other suitable fluidic coupling. Of course, tubes 12a-12k can also be molded or bonded together to form either fluidic or non-fluidic initerconnections. As shown in FIG. 3A, first and second tubes 12, which represent any of tubes 12a-12k, can be interconnected in fluid communication using a snap-coupling 40 having a male portion 40a that is received by a female portion 40b. The male portion 40a comprises a snap collar 42a and the female portion 40b is defined as part of a boss 42b. The snap collar 42a releasably engages the boss 42b when the male and female portions 40a,40b are mated so as to hold the tubes 12 together in a fluid-tight arrangement. Regardless of the connection means used, the frame 12 is able to be disassembled and/or collapsed for storage. In one preferred embodiment, the tubes 12a-12k of the frame 12 are telescopically interconnected with each other so that they can be telescopically collapsed for storage and telescopically extended into the illustrated operative state. When telescopically extended into an operative state, the tubes 12a-12k preferably snap into the fully extended position.

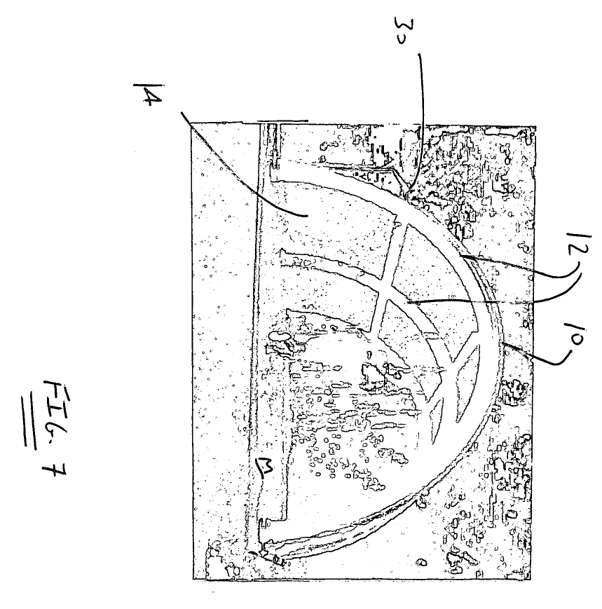

At least some of the tubes 12a-12k, and preferably all of the arch tubes 12c-12g, include or define water spray heads 50 from which water spray W is emitted under pressure owing to the water supplied from the hose 32 via fitting 30. As shown in FIG. 5, the spray heads 50 are each preferably defined by one or more apertures or orifices 52 defined in the tubes 12a-12k. The number, size, shape and arrangement of the orifices 52 can be varied for each spray head 50 to control the pattern in which water spray W is emitted therefrom. In general, it is preferred that the water spray W be emitted from the heads 50 as a mist or light spray pattern rather than as a simple single stream. The spray heads 50 can be embedded into the tubes 12a-12k and fixed in position so as to emit a select spray pattern. An alternative spray head 50′ is shown in FIG. 6 and comprises a head portion 54 including orifices 56 defined therein through which water is emitted. The head portion 54 rotates in response to water pressure from the flow F so that the water spray W moves in a circular pattern in response to rotation of the head 54. In all cases, it is preferred that the water spray W be directed in multiple directions throughout the enclosure 10. For example, water spray W originating from the central arch tubes 12d,12e,12f is preferably directed downward and also toward both ends 22a,22b; water spray W originating at the end arch tubes 12c,12g is preferably directed downward and inwardly toward the center of the enclosure 10. The spray heads 50 can also comprise shower heads. In any case, including at least one and preferably multiple spray heads 50 on each arched tube 12c-12g is critical for maximum coverage of the spray pattern W in a manner that will encompass a person within the enclosure 10 with minimum pressure loss. The spray heads 50,50′ can be located in any tube 12a-12k that forms part of the flow path F, including the tubes 12a,12b.

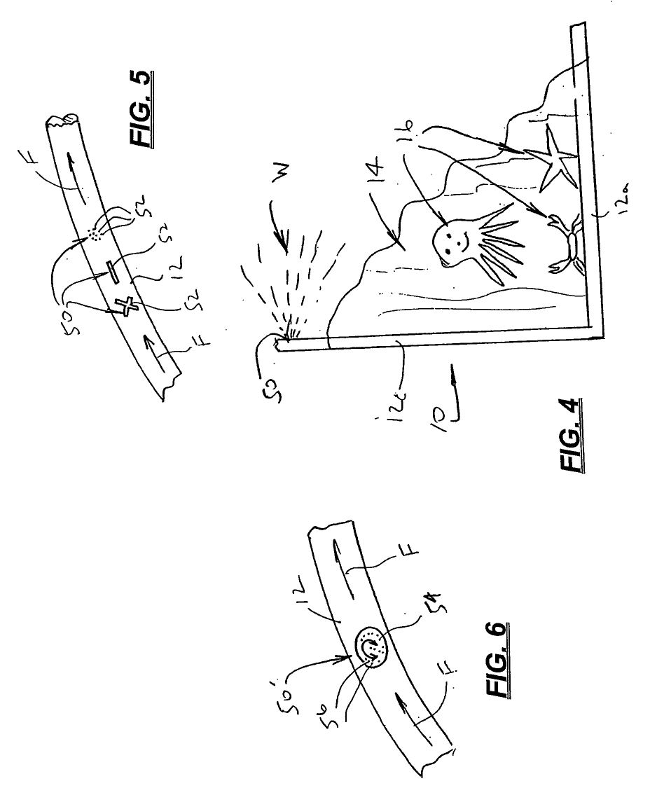

As mentioned, the enclosure 10 comprises a covering 14 connected to and at least substantially coextensive with the frame 12. The covering 14 cooperates with the frame 12 to define the tunnel-like enclosure. The covering 14 is preferably draped over the arch tube members 12c-12g as shown so as to define the tunnel-like enclosure with the open mouths 24a,24b at the ends 22a,22b. In addition to the ends 22a,22b being uncovered to define the mouths 24a,24b, the enclosure 10 can have an open, uncovered floor, i.e., the grass or other support surface on which the frame 12 is erected and supported can define the floor of the enclosure 10. Preferably the enclosure comprises a plastic or rubber floor mat M defined from a sheet material that is connected to or separate from the frame 12. The floor mat M can be a simple sheet structure, but it is preferably a multi-walled structure that is filled with a fluid such as air or water for cushioning. The covering 14 is preferably defined from one or more plastic sheets such as PVC or other plastic sheets that are releasably secured to the frame 12 via adhesive, hook-and-loop fastening elements, adhesive, hooks/eyelets, snaps, magnets and/or other suitable convenient fastening means. The covering 14 is preferably transparent or at least translucent so that at least some light passes therethrough into the enclosure 10. In one preferred embodiment as shown in FIG. 4, the covering 14 is defined from blue, blue/green or similar colored translucent plastic sheets that simulate the appearance of the ocean in sunlight. Furthermore, the covering 14 preferably comprises aquatic indicia 16 such as fish, bubbles, underwater plants and/or other underwater objects or animals printed or otherwise included thereon. In this case, children or others inside the enclosure 10 are presented with an optical illusion of being underwater as might be encountered during scuba diving or swimming.

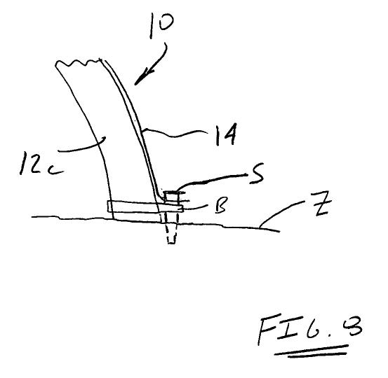

The wet loop water spray enclosure 10 provides a safe, effective and fun means for allowing children and others to be sprayed with water W for cooling and amusement purposes. As shown in FIG. 7, children or other users enter the enclosure 10 via either mouth 24a,24b and walk or run through and/or within the enclosure 10 to encounter the water spray W. The preferred translucent water-colored (blue, green, etc.) covering 14 with aquatic indicia 16 thereon, in combination with the water spray W, provides an illusion of being underwater in the ocean to those within the enclosure 10. The enclosure 10 can also be readily disassembled for storage as described.

The enclosure 10 can be self-supporting via frame 12 or can be anchored to the earth or other support surface using spikes, straps, weights, and/or other suitable means. FIG. 8 partially shows an enclosure 10 supported on a surface Z. In the illustrated example, the enclosure comprises multiple support brackets B connected to the frame 12 such as the frame member 12c, and a spike S is engaged with the bracket B and driven into the surface Z. Preferably, as shown, the spike S is also engaged with the covering 14 to secure same.

Modifications and alterations will occur to those of ordinary skill in the art upon reading this specification. It is intended that the present invention be construed as encompassing all such modifications and alterations.

1. A water spray enclosure comprising:
a plurality of interconnected tubes defining a framework, wherein at least some of said plurality of tubes are fluidically interconnected to each other so as to define a flow-path through said framework;
a flexible covering connected to and substantially coextensive with said framework and cooperating with said framework to define a tunnel-like enclosure having opposite first and second open ends and an enclosure portion between said ends, wherein said covering is at least partially translucent;
an inlet fitting connected to one of said tubes of said framework and in fluid communication with said flow-path, said inlet fitting adapted for fluidic connection to a water supply conduit for supplying water to said flow-path;
a plurality of spray heads in communication with said flow-path and adapted for emitting a spray of water from said flow path into said enclosure portion between said first and second open ends.

2. The water spray enclosure as set forth in claim 1, wherein said flow-path of said framework is at least partially defined by a plurality of arched tubes arranged in spaced parallel relation between said first and second open ends of said tunnel-like enclosure.

3. The water spray enclosure as set forth in claim 2, wherein at least some of said spray heads are defined apertures defined in said flow-path portion of said framework.

4. The water spray enclosure as set forth in claim 2, wherein said covering comprises aquatic indicia thereon to simulate and underwater experience to a person located within said tunnel-like enclosure.

5. The water spray enclosure as set forth in claim 4, further comprises a floor mat positioned with said tunnel-like enclosure.

6. The water spray enclosure as set forth in claim 5, wherein said floor mat defines a spaced to be filled with air or water.

7. The water spray enclosure as set forth in claim 6, further comprising a plurality of support brackets connected to said framework and a plurality of spikes for respectively engaging said brackets and a support surface to anchor said framework to said support surface.

8. The water spray enclosure as set forth in claim 7, wherein each of said spikes also engages said covering to secure said covering relative to said framework.

9. The water spray enclosure as set forth in claim 2, further comprising a pump to increase fluid pressure in said flow-path.

10. The water spray enclosure as set forth in claim 9, further comprising an oscillator for pulsating water flowing in said flow path.

11. The water spray enclosure as set forth in claim 7, wherein said tubes of said framework are releasably interconnected.

12. The water spray enclosure as set forth in claim 6, wherein said framework further comprises:
at least two parallel axially extending base tubes extending between said first and second open ends and adapted to contact a support surface on which said framework is erected; and,
at least two intermediate tubes that form a part of said flow-path and that lie parallel to and spaced from said base tubes, wherein said intermediate tubes are in fluid communication with each of said arched tubes.
